(19) United States
(12) Patent Application Publication
(10) Pub. No.: US 2026/0267536 A1
(43) Pub. Date: Sep. 10, 2026

(54) ALTERING A CLOCK FREQUENCY OF A PROCESSING UNIT IN A DATA STORAGE DEVICE TO PROVIDE POWER TO AN INACTIVE META-DIE

(71) Applicant: Sandisk Technologies, Inc., Milpitas, CA (US)

(72) Inventors: Saurabh Singh, Bangalore (IN); Amit Sharma, Bangalore (IN); Niranjana Bhatta G M, Karnataka (IN)

(21) Appl. No.: 19/071,127

(22) Filed: Mar. 5, 2025

(51) Int. Cl. G06F 3/06

(52) U.S. Cl. CPC G06F 3/0625; G06F 3/0655; G06F 3/0679

(57) ABSTRACT

A data storage device includes a power management system that changes a power state of the data storage device based, at least in part, on an operating mode of the data storage device and on properties of one or more commands received from a host device. Changing power states enables the data storage device to provide power to more than a maximum number of memory dies specified by power constraints of a protocol, while still conforming to the specified power constraints.

### BACKGROUND

As the capacity of data storage devices continues to increase, so do the number of memory dies that are included in the data storage device. However, some communication protocols put a limit on an amount of power that can be consumed by the data storage device and/or the memory dies. For example, the Universal Serial Bus (USB) 3.1 protocol indicates that the maximum power allowed in an external data storage device is 4.5 Watts (W).

In order to adhere to these power consumption constraints, firmware of the data storage device typically limits the number of memory dies that are active at the same time. This significantly reduces power consumption of the data storage device.

However, some operations, in combination with the power constraints, cause a significant drop in performance of the data storage device. For example, during a sustained write mode, because only a subset of memory dies are active due to the power constraints, performance of the data storage device drops significantly when compared with other operating modes (e.g., a sequential read mode, a burst sequential write mode, etc.)

Accordingly, it would be beneficial for a data storage device to have various power states based, at least in part, on determined operating modes of the data storage device.

### SUMMARY

The present application describes a power management system for a data storage device, such as, for example, a NAND data storage device. In an example, the power management system is operable to determine an operating mode, or an operating state, of the data storage device. Based, at least in part, on the determined operating mode of the data storage device, the power management system determines whether to enter a particular power state or power profile. When in the particular power state, a clock frequency of one or more processors, or processing units, of the data storage device is reduced. A reduction in the clock frequency of the one or more processes reduces the power consumption of the data storage device.

Any power savings that is achieved by the clock frequency reduction is routed or otherwise provided to inactive memory dies of the data storage device. Relocation operations can then be performed on inactive (and now active) memory dies, while still adhering to the power constraints of a particular protocol. As a result, more relocation operations, such as on-chip copy relocation operations, can be performed on more memory dies when compared with current solutions.

Accordingly, examples of the present disclosure describe a method that includes determining an operating mode of a data storage device. Based, at least in part, on the determined operating mode, one or more commands in a command queue are analyzed to determine one or more properties of each command. Based, at least in part, on the one or more properties associated with each command, a storage state of an inactive meta-die of the data storage device is determined. A power state of the data storage device is changed from a first state to a second state in which a clock frequency of at least one processor of the data storage device is reduced when compared to the clock frequency of the at least one processor in the first state. Any power saved by reducing the clock frequency of the at least one processor is diverted to the inactive meta-die thereby causing the inactive meta-die to be an active meta-die.

Other examples describe a data storage device that includes at least one controller and a power management system associated with the controller. The power management system is operable to determine whether the data storage device is operating in a sustained write mode. Based, at least in part, on determining the data storage device is operating in the sustained write mode, one or more commands in a command queue are analyzed to determine one or more properties associated with each command in the command queue. A determination is also made regarding whether a value associated with the one or more properties exceeds a properties threshold. Based, at least in part, on determining the value associated with the one or more properties exceeds the properties threshold, a determination is made regarding a storage state of an inactive meta-die of the data storage device. Based, at least in part, on the storage state of the inactive meta-die, a clock frequency of the least one controller of the data storage device is changed from a first clock frequency to a second clock frequency. In an example, the second clock frequency is lower than the first clock frequency. Any power saved by changing the clock frequency of the at least one controller from the first clock frequency to the second clock frequency is provided to the inactive meta-die, thereby causing the inactive meta-die to be an active meta-die.

Still other examples describe a data storage device that includes means for determining whether the data storage device is operating in a sustained write mode and means for analyzing one or more commands in a command queue. The data storage device also includes means for determining one or more properties associated with each command in the command queue and means for determining whether a value associated with the one or more properties exceeds a properties threshold. In an example, the data storage device also includes means for determining a storage state of an inactive meta-die of the data storage device and means for changing a clock frequency of at least one processor of the data storage device from a first clock frequency to a second clock frequency, the second clock frequency being lower than the first clock frequency. Additionally, the data storage device includes means for providing power saved by changing the clock frequency of the at least one processor from the first clock frequency to the second clock frequency to the inactive meta-die, thereby causing the inactive meta-die to be an active meta-die.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of a system that includes a host device and a data storage device according to an example.

FIG. 2 illustrates a memory device having a number of meta-dies according to an example.

FIG. 3 illustrates a controller of a data storage device receiving a number of commands according to an example.

FIG. 4 illustrates different operating states of a data storage according to an example.

FIG. 5A illustrates one or more operations being performed on memory dies of an active meta-die according to an example.

FIG. 5B illustrates one or more operations being performed on memory dies of an inactive meta-die according to an example.

FIG. 6 illustrates a method for managing a power state of a data storage device according to an example.

FIG. 7 is a perspective view of a storage device that includes three-dimensional (3D) stacked non-volatile memory according to an example.

FIG. 8 is a block diagram of a storage device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

Demand for data storage devices continues to increase. As demand increases, so do the demands for increased capacity and higher performance. In order to match the increasing demand, the number of memory dies in the data storage device is increasing. However, some data storage devices, such as external data storage devices, are subject to power constraints or restrictions posed by various protocols. These power constraints limit the number of memory dies that are active at a given time.

For example and as previously described, the Universal Serial Bus (USB) 3.1 protocol specifies that the maximum power allowed in an external data storage device is 4.5 Watts (W). Due to these power constraints, not all memory dies of the data storage device can operate in parallel. For example, if the data storage device has sixty-four memory dies in parallel, the power constraints of the USB 3.1 protocol specifies that only a certain number (e.g., sixteen) of those memory dies can be active at a given time.

To address this, firmware of the data storage device implements a meta-die architecture. The meta-die architecture limits the number of active memory dies at a given time. This reduces peak power consumption of the data storage device and enables the data storage device to conform with the power constraints.

Continuing with the example above, in which the data storage device has sixty-four memory dies, meta-dies are formed in which each meta-die is comprised of sixteen memory dies. As a result, the data storage device consists of four meta-dies. However, only one meta-die can be active at a time.

However, some operations, in combination with these power constraints, cause a significant drop in performance metrics of the data storage device. For example, during a sustained write mode, performance of the data storage device drops significantly when compared with other operating modes (e.g., a sequential read mode, a burst sequential write mode). This is due, in part, because only a subset of memory dies are active due to the power constraints.

To address the above, the present disclosure describes a power management system for a data storage device. In an example, the data storage device is a NAND data storage device. In yet another example, the data storage device is an external data storage device that is removably coupled to a host computing device.

The power management system of the data storage device provides a way to operate more than the maximum number of memory dies specified by the power constraint of a protocol. For example, if the power constraint of the protocol specifies that a maximum of sixteen memory dies may be active in parallel, the power management system provides a way in which more than sixteen dies can be active while still conforming to the power requirements and/or constraints. Specifically, in an example, the power management system provides a way in which more than the maximum number of memory dies specified in the protocol may be active in parallel when the data storage device is in a sustained write mode (also referred to as a sustain sequential write mode).

The power management system is able to enter various power states. These power states provide various power profiles that are based, at least in part, on one or more operating modes of the data storage device. For example, one power state (referred to herein as a “sustained state”), is a power state in which the workload is not processor intensive. When in this power state, the power management system reduces a clock frequency of the processor to save power (e.g., from a system on a chip (SoC)). The power management system uses the power savings to operate a greater number of memory dies when compared with current solutions. A relocation system associated with the power management system may also perform folding operations on the newly active meta-die.

Accordingly, many technical benefits may be realized including, but not limited to increasing a rate at which memory blocks of memory dies of various inactive meta-dies are freed during relocation operations, thereby increasing the performance characteristics of the data storage device.

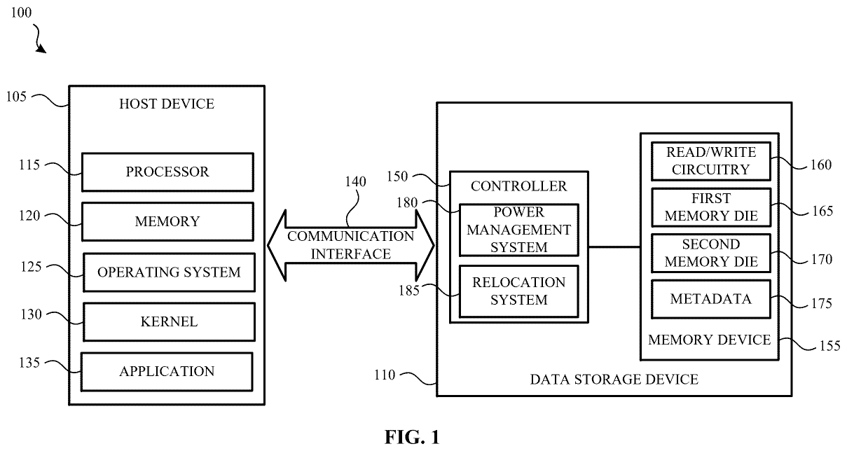

These benefits, along with other examples, will be shown and described in greater detail with respect to FIG. 1-FIG. 8.

FIG. 1 is a block diagram of a system 100 that includes a host device 105 and a data storage device 110 according to an example. In an example, the host device 105 includes at least one processor 115 and a memory 120 (e.g., main memory). The memory 120 includes or is otherwise associated with an operating system 125, a kernel 130 and/or an application 135.

The processor 115 can execute various instructions, such as, for example, instructions from the operating system 125 and/or the application 135. The processor 115 may include circuitry such as a microcontroller, a Digital Signal Processor (DSP), an Application-Specific Integrated Circuit (ASIC), a Field Programmable Gate Array (FPGA), hard-wired logic, analog circuitry and/or various combinations thereof. In an example, the processor 115 may include a System on a Chip (SoC).

In an example, the memory 120 can be used by the host device 105 to store data used, or otherwise executed by, the processor 115. Data stored in the memory 120 may include instructions provided by the data storage device 110 via a communication interface 140. The data stored in the memory 120 may also include data used to execute instructions from the operating system 125 and/or one or more applications 135. The memory 120 may be a single memory or may include multiple memories, such as, for example one or more non-volatile memories, one or more volatile memories, or a combination thereof.

In an example, the operating system 125 creates a virtual address space for the application 135 and/or other processes executed by the processor 115. The virtual address space maps to locations in the memory 120. The operating system 125 also includes or is otherwise associated with a kernel 130. The kernel 130 includes instructions for managing various resources of the host device 105 (e.g., memory allocation), handling read and write requests and so on.

The communication interface 140 communicatively couples the host device 105 and the data storage device 110. The communication interface 140 may be a Serial Advanced Technology Attachment (SATA), a PCI express (PCIe) bus, a Small Computer System Interface (SCSI), a Serial Attached SCSI (SAS), Ethernet, Fibre Channel, or Wi-Fi. As such, the host device 105 and the data storage device 110 need not be physically co-located and may communicate over a network such as a Local Area Network (LAN) or a Wide Area Network (WAN), such as the internet. In addition, the host device 105 may interface with the data storage device 110 using a logical interface specification such as Universal Serial Bus (USB), Non-Volatile Memory express (NVMe) or Advanced Host Controller Interface (AHCI).

The data storage device 110 includes at least one controller 150, processor and/or processing unit and at least one memory device 155. The controller 150 is communicatively coupled to the memory device 155. In an example, the data storage device 110 may include multiple controllers, processors or processing units. In such an example, one controller is responsible for executing a first operation or set of operations and a second controller is responsible for executing a second operation or set of operations.

In an example, the memory device 155 includes one or more memory dies (e.g., first memory die 165 and second memory die 170). Although two memory dies are shown, the memory device 155 may include any number of memory dies (e.g., one memory die, two memory dies, eight memory dies, or another number of memory dies). Additionally, although memory dies are specifically mentioned, the memory device 155 may include any non-volatile memory device, storage device, storage elements or storage medium including NAND flash memory cells and/or NOR flash memory cells.

The memory cells can be one-time programmable, few-time programmable, or many-time programmable. Additionally, the memory cells may be single-level cells (SLCs), multi-level cells (MLCs), triple-level cells (TLCs), quad-level cells (QLCs), penta-level cells (PLCs), and/or use any other memory technologies. The memory cells may be arranged in a two-dimensional configuration or a three-dimensional configuration.

In an example, one or more of the first memory die 165 and the second memory die 170 include one or more planes and each of the one or more planes includes one or more memory blocks. In an example, each memory block includes one or more pages made up of one or more memory cells. A block of memory cells is the smallest number of memory cells that are physically erasable together. In an example and for increased parallelism, each of the memory blocks may be operated or organized in larger blocks or metablocks. For example, one block from different planes may be logically linked together to form a metablock.

In an example, the data storage device 110 and/or the memory device 155 may include or otherwise be associated with different partitions, such as, for example, a first memory partition and a second memory partition. Each memory partition includes different types of memory blocks. For example, the first memory partition may be identified as a cache partition and include a number of SLC memory blocks. The second memory partition may be identified as a primary storage partition and include a number of QLC memory blocks. Although QLC memory blocks are specifically mentioned, the primary storage partition may include MLC memory blocks, TLC memory blocks, and/or PLC memory blocks.

Additionally, the data storage device 110 may implement a hybrid architecture. As such, a subset of the QLC memory blocks may be identified as hybrid memory blocks. Accordingly, each hybrid memory block may be programmable in a first mode (e.g., a QLC mode) or a second mode (e.g., a SLC mode).

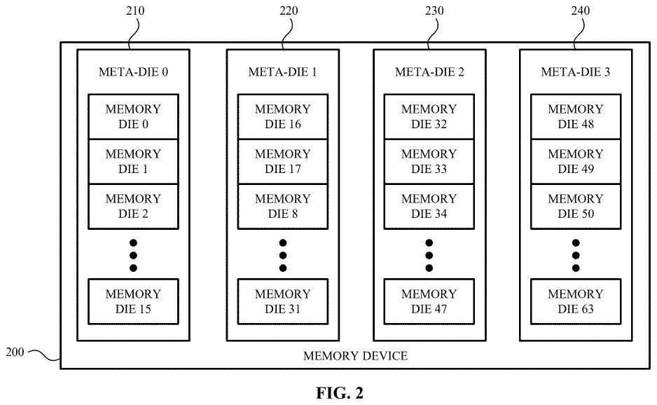

In an example, the data storage device 110 implements a meta-die architecture. For example, and referring to FIG. 2, FIG. 2 illustrates a memory device 200 having a number of meta-dies according to an example. The memory device 200 may be similar to the memory device 155 shown and described with respect to FIG. 1. However, in this example, the memory device 200 includes sixty-four memory dies (e.g., Memory Die 0-Memory Die 63). Although sixty-four memory dies are shown and described, the memory device 200 may have more than sixty-four memory dies or fewer than sixty-four memory dies.

In an example, and due to power constraints specified by one or more protocols, only a certain number of memory dies may be active at a time. For example, the protocol may specify that only sixteen memory dies may be active at a given time. As such, the sixty-four memory dies are organized or grouped into four meta-dies, with each meta-die including sixteen memory dies.

For example, Meta-Die 0 210 includes Memory Die 0-Memory Die 15; Meta-Die 1 220 includes Memory Die 16-Memory Die 31; Meta-Die 2 230 includes Memory Die 32-Memory Die 47; and Meta-Die 3 240 includes Memory Die 48-Memory Die 64. In current solutions, only a single meta-die can be active at a given time.

However, and as will be explained in greater detail herein, a power management system (e.g., a power management system 180 (FIG. 1)) provides a way to operate more than the maximum number (e.g., sixteen) of memory dies specified by the power constraint of the protocol. For example, when the data storage device is in a particular mode (e.g., a sustained write mode or a sustain sequential write mode), the power management system causes the data storage device to enter a particular power state. When operating in this particular power state, the power management system reduces a clock frequency of a controller/processor/processing unit to save power. The power management system then uses or redirects the power savings to operate more than the maximum number of memory dies specified by the power constraint of the protocol.

For example, if Meta-Die 0 210 was the active meta-die and Memory Die 0-Memory Die 15 were the sixteen active memory dies, the power management system could direct the power saved by reducing the clock frequency of the controller to Meta-Die 1 220 (or the other meta-dies), thereby activating one or more of the memory dies (e.g., Memory Die 16-Memory Die 31) associated with Meta-Die 1 220. When Meta-Die 1 220 is active, a relocation system associated with the power management system may perform one or more relocation operations (e.g., folding operations) on the memory dies of the newly active Meta-Die 1 220.

Referring back to FIG. 1, in some examples, the data storage device 110 may be attached to, or embedded within, the host device 105. In another example, the data storage device 110 may be implemented as an external device or a portable device that can be communicatively or selectively coupled to the host device 105. In yet another example, the data storage device 110 may be a component (e.g., a solid-state drive (SSD)) of a network accessible data storage system, a network-attached storage system, a cloud data storage system, and the like.

The memory device 155 may also include support circuitry. In an example, the support circuitry includes read/write circuitry 160. The read/write circuitry 160 supports the operation of the memory dies of the memory device 155. Although the read/write circuitry 160 is depicted as a single component, the read/write circuitry 160 may be divided into separate components, such as, for example, read circuitry and write circuitry. The read/write circuitry 160 may be external to the memory dies of the memory device 155. In another example, one or more of the memory dies may include corresponding read/write circuitry 160 that is operable to read data from and/or write data to storage elements within one individual memory die independent of other read and/or write operations on any of the other memory dies.

The memory device 155 may also store metadata 175. The metadata 175 may include information about the memory device 155 and/or information about each of the first memory die 165 and the second memory die 170. In another example, the metadata 175 may include information about one or more properties of one or more commands that are received from the host device 105. In other examples, the metadata 175 indicates which memory dies are active, which memory dies are inactive and which memory dies are part of a meta-die.

As previously described, the data storage device 110 includes at least one controller 150. Although a controller 150 is specifically mentioned, the controller 150 may be a processor, multiple processors, a processing unit, processing circuitry and the like. The controller 150 is communicatively coupled to the memory device 155 via a bus, an interface or other communication circuitry.

In an example, the communication circuitry may include one or more channels to enable the controller 150 to communicate with the first memory die 165 and/or the second memory die 170 of the memory device 155. In another example, the communication circuitry may include multiple distinct channels which enables the controller 150 to communicate with the first memory die 165 independently and/or in parallel with the second memory die 170 of the memory device 155.

The controller 150 may receive data and/or instructions from the host device 105. The controller 150 may also send data to the host device 105. For example, the controller 150 may send data to and/or receive data from the host device 105 via the communication interface 140. The controller 150 may also send data and/or commands to and/or receive data from the memory device 155.

The controller 150 may send data and a corresponding write command to the memory device 155 to cause the memory device 155 to store data at a specified address of the memory device 155. In an example, the write command specifies a physical address of a portion of the memory device 155. The controller 150 may also send data and/or commands associated with one or more background scanning operations, garbage collection operations, and/or wear leveling operations. The controller 150 may also send one or more read commands to the memory device 155. In an example, the read command specifies the physical address of a portion of the memory device 155 at which the data is stored.

The controller 150 may also include or otherwise be associated with a power management system 180 and a relocation system 185. The power management system 180 and/or the relocation system 185 may be a packaged functional hardware unit designed for use with other components/systems, a portion of a program code (e.g., software or firmware) executable by the controller 150, a processor and/or processing circuitry, or a self-contained hardware and/or software component that interfaces with other components and/or systems.

In an example, the power management system 180 is configured or operable to determine an operating mode of the data storage device 110. If the power management system 180 determines the data storage device 110 is operating in a particular operating mode, the power management system 180 analyzes a number of commands received from the host device 105. In an example, the commands are temporarily stored in a command queue. Based on or more properties associated with the commands in the command queue, and/or on a storage state of an inactive meta-die of the data storage device 110, the power management system 180 determines whether to change a power state (or implement a power profile) of the data storage device 110.

In an example, when the power management system 180 determines to change the power state of the data storage device 110, a clock frequency of the controller 150 is reduced (e.g., when compared with other power states of the data storage device). As a result of the reduction in the clock frequency of the controller 150, the data storage device 110 will consume less power. The power savings provided by reduction in consumed power will be provided to one or more memory dies of one or more inactive meta-dies. The relocation system 185 may then perform one or more relocation operations on the active meta-die and on the newly active meta-die (e.g., the meta-die to which the power management system 180 provided the “saved” power).

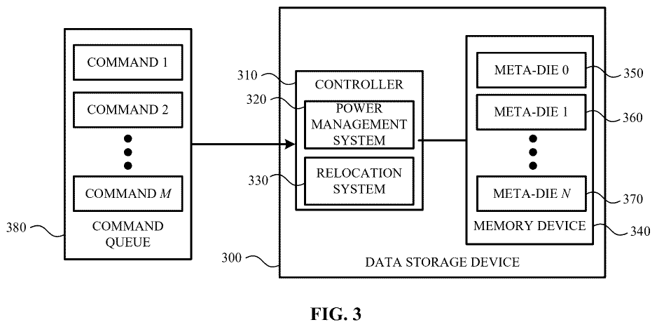

FIG. 3 illustrates a controller 310 of a data storage device 300 receiving a number of commands according to an example. In an example, the data storage device 300 and the controller 310 are similar to the data storage device 110 and the controller 150 shown and described with respect to FIG. 1. As such, the controller 310 includes a power management system 320 and a relocation system 330.

The data storage device 300 also includes a memory device 340. In an example, the memory device 340 includes a number of different meta-dies. For example, the memory device 340 includes Meta-Die 0 350, Meta-Die 1 360 and Meta-Die N 370. In an example, the meta-dies shown and described with respect to FIG. 3 are similar to the meta-dies shown and described with respect to FIG. 2.

In an example, the commands are received from a host device, such as, for example, the host device 105 shown and described with respect to FIG. 1. When the commands are received, the commands are placed in a command queue 380. As shown in FIG. 3, the command queue 380 includes Command 1-Command M. In an example, and to determine whether to enter a power saving state (e.g., a sustained state), the power management system 320 and/or the controller 310 first determines an operating mode of the data storage device 300.

In an example, the operating mode of the data storage device 300 includes, but is not limited to, a sequential sustained read mode, a sequential sustained write mode, a burst sequential write mode, a sustain random read mode and a burst random read mode. In an example, each of these mode may be based, at least in part, on a number of free memory blocks that are available in one or more of the meta-dies of the memory device 340.

For example, when the controller 310 determines or detects there is not enough SLC memory blocks available to continue in a burst sequential write mode, the controller 310 causes the relocation system 330 to start one or more relocation operations. For example, the controller 310 causes the relocation system 330 to initiate one or more folding operations in which data from multiple SLC memory blocks are folded or combined into a QLC memory block. This operation frees up SLC memory blocks so that SLC memory blocks are available for host writes.

In an example, an in order to enter the sustained state, the data storage device 300 is operating in the sequential sustained write mode. If the data storage device 300 is not operating in the sequential sustained write mode, the power management system 320 cannot change the power state of the data storage device 300 to the sustained state.

Based on a determination that the data storage device 300 has entered the sequential sustained write mode, the power management system 320 analyzes one or more commands in the command queue 380. The analysis is used to determine one or more properties associated with each command in the command queue 380. For example, the power management system 320 determines a command type for Command 1, Command 2, and Command M. In an example, the command type is one of a write command, a read command, or an erase command.

When the write commands are identified, the power management system 320 determines whether the number of write commands in the command queue 380 exceed a write command threshold. In an example, the write command threshold can be dynamic and may be based, at least in part, on the number of memory blocks available to keep the data storage device 300 in a burst mode. In another example, the write command threshold may be based, at least in part, on a total number of commands that are received at a given time. In yet another example, write commands are determined by the run length per command in the command queue 380.

The power management system 320 also determines whether the write commands are random or sequential. In an example, this determination is made by identifying a logical block address (LBA) associated with the commands in the command queue 380. If the LBAs associated with the write commands are sequential, the write commands are sequential write commands.

The power management system 320 also determines a run length of each sequential write command. In an example, the run length indicates how much data will be written during each sequential write command. When the run length of the sequential write commands in the command queue 380 is identified, the power management system 320 determines whether the run length of the sequential write commands exceeds a run length threshold. In an example, the run length threshold is based, at least in part, on an amount of space available in SLC memory blocks. The number of SLC memory blocks available for host data can be dynamic based, at least in part, on wear leveling schemes. As a result, the run length threshold may be dynamic. In another example, the run length threshold is static.

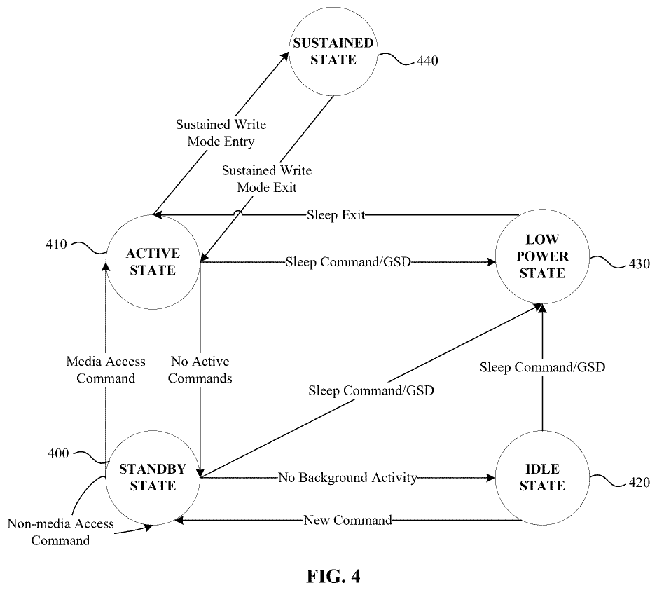

In an example, if any of the above conditions are not satisfied, the data storage device 300 will not enter the sustained state. Rather, the data storage device 300 will remain in an active state (see FIG. 4).

However, if all of the above conditions are satisfied, the power management system 320 will determine whether a relocation operation should be performed on one or more inactive meta-dies. For example, the relocation system 330 and/or the power management system 320 will determine a number of free SLC memory blocks in one or more of the inactive meta-dies and determine, based at least in part, on the number of free SLC memory blocks, whether to initiate a relocation operation on that particular inactive meta-die.

In an example, the relocation operation is an On-Chip Copy (OCC) relocation operation. An OCC relocation operation is used when data disturbance is low and there is no need to correct the relocated data using an error correction code (ECC) engine. For example, data stored in the SLC memory blocks is moved to QLC memory blocks without being toggled to random access memory (RAM) or without low-density parity check (LDPC) error correction. Rather, any errors that are present in the SLC memory blocks are propagated to the QLC memory blocks. However, an enhanced post write read (EPWR) process is subsequently performed to check whether the QLC errors cross a specified error threshold. In an example, this is fastest relocation approach for moving the data without occupying flash interface module (FIM) bandwidth and without dedicated buffer requirements for moving the data.

Based, at least in part, on determining a relocation operation should be performed on one or more of the inactive meta-dies, the power management system 320 changes a power state of the data storage device 300 from a first state (e.g., an active state) to a second state (e.g., the sustained state). As part of this process, the power management system 320 lowers or reduces a clock frequency of the controller 310 of the data storage device 300.

In an example, changing the clock frequency of the controller 310 saves power because a lower clock speed means the controller performs fewer operations per second when compared to the unchanged or original clock frequency. As a result, the controller 310 consumes less energy. For example, the controller 150 is doing less work at a lower frequency and therefor, draws less of the available power which means, more power is available for inactive memory dies.

In response to the clock frequency of the controller 310 being lowered, the relocation system 330 initiates the relocation operation on one or more of the inactive meta-dies. In an example, the power management system 320 and/or the relocation system 330 prepares a pipeline for folding operations. However, these folding operations are not intensive. Additionally, writing data to SLC memory blocks is also not intensive. As such, the controller 310 remains mostly in idle state while in the sustained write operation.

As a result, the power management system 320 can have power profiles based on the various modes of operation such as previously described and can provide power to more memory dies while still adhering to the power requirements of a protocol. For example, when there is no intensive workload, the power management system 320 can reduce the clock frequency to save power and can use this power to operate a greater number of memory dies and perform folding operations on the different meta-dies.

FIG. 4 illustrates different operating states of a data storage according to an example. In an example, the data storage device 110 shown and described with respect to FIG. 1 and/or the data storage device 300 shown and described with respect to FIG. 3 can operate in the various operating states.

In an example, the data storage device can operate in a standby state 400, an active state 410, an idle state 420 and a low power state 430. In the standby state 400, the data storage device is waiting for a command (e.g., from a host device). However, when a command is received, the data storage device enters the active state 410. In an example, when in the active state 410, one or more commands or operations are being performed on one or more memory dies of a particular meta-die.

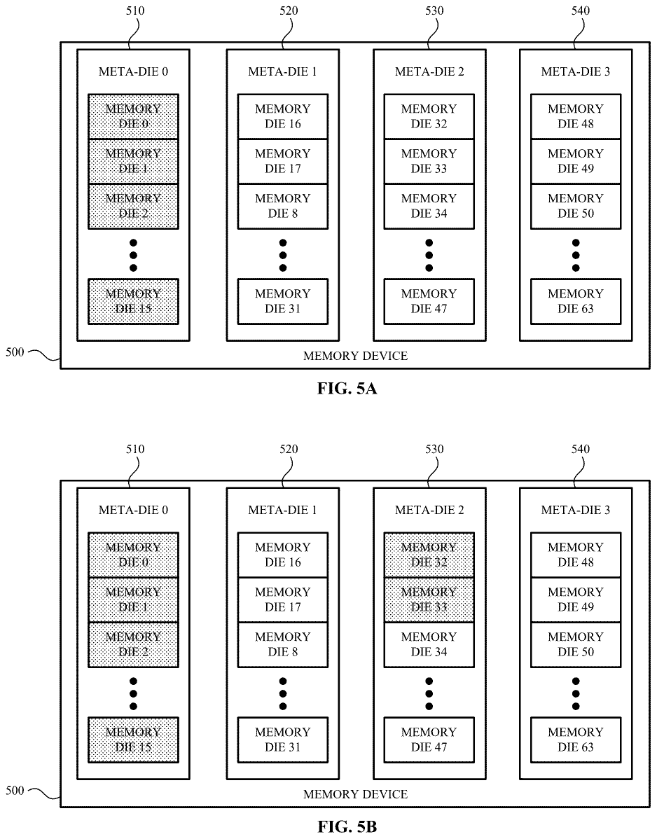

For example and referring to FIG. 5A, FIG. 5A illustrates one or more operations being performed on memory dies of an active meta-die according to an example. For example and as previously explained, due to power constraints specified by a protocol, when the data storage device is in the active state, only the memory dies of Meta-Die 0 510 may be active (represented by the shading of the various memory dies). All of the other meta-dies in the memory device 500 are inactive. For example, Meta-Die 1 520, Meta-Die 2 530 and Meta-Die 3 540 are all inactive.

Referring back to FIG. 4, if a command is not received by the data storage device, or there are no background operations to be performed (e.g., garbage collection operations, relocation operations), the data storage device enters an idle state 420. In the idle state 420, the data storage device is in a power saving state. When the data storage device is in the idle state 420, or the standby state 400, and a sleep command is received, the data storage device enters a low power state 430.

However, and as shown in FIG. 4, when the data storage device in in the active state 410 and the power management system determines that the data storage is in a particular mode, such as, for example, a sustained write mode, the data storage device may enter a sustained state 440. In the sustained state, the power management system reduces a clock frequency of the controller of the data storage device such as previously described.

As a result of entering the sustained state, a relocation system may perform one or more relocation operations on inactive meta-dies. For example and referring to FIG. 5B, FIG. 5B illustrates one or more operations being performed on memory dies of an inactive meta-die according to an example. For example, due to the power savings previously described, relocation operations (e.g., OCC operations) may be performed on Memory Die 32 and Memory die 33 of inactive Meta-Die 2 (now classified as active).

In an example, as SLC memory blocks are folded into QLC memory blocks (e.g., as part of being in the sustained state 440 and/or as part of the OCC process), SLC memory blocks are freed up or are otherwise made available. As a result, the memory device 500 will have more SLC memory blocks to support burst writes from a host device. Thus, once a threshold number of free SLC memory blocks is reached, the memory device 500 can transition from the sustained state 440 (FIG. 4) to another state (e.g., a burst mode or a burst state).

In an example, if random read commands are in the command queue while the data storage device is in the sustained write mode (and since random read commands are an intensive command), operating with a lower clock frequency may negatively impact the random read performance of the data storage device. As a result, the power management system can make the decision to go back to a “normal mode” (e.g., the active state 410) or a burst mode based on a threshold number of random reads being sent by the host device. However, if there are under a threshold number of random reads being sent by the host device, the power management system may opt to stay in the sustained state 440 while taking a hit on random read performance.

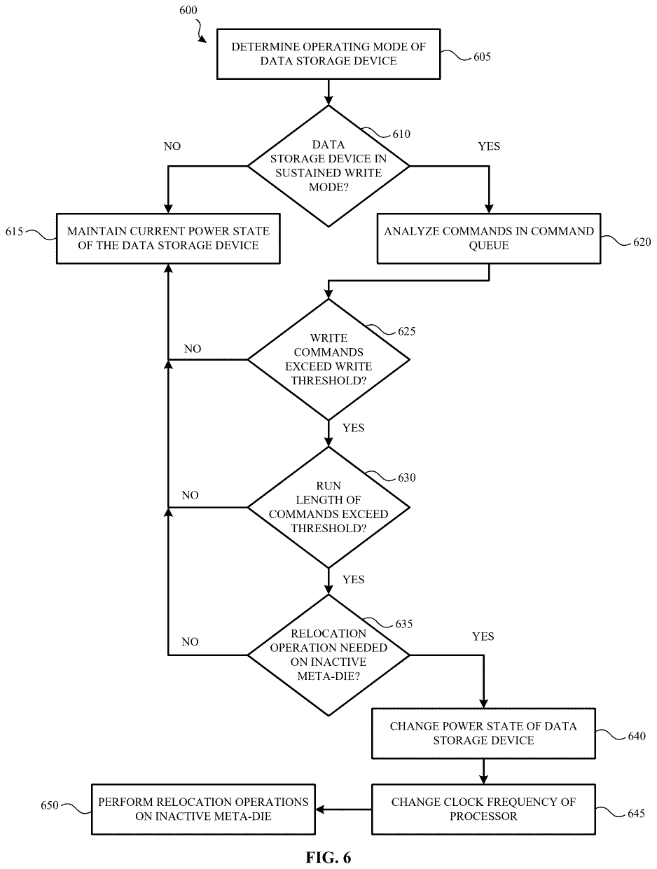

FIG. 6 illustrates a method 600 for managing a power state of a data storage device according to an example. In an example, the method 600 may be performed by controller, a power management system and/or a relocation system of a data storage device. For example, the method 600 may be performed by the controller 150, the power management system 180 and/or the relocation system 185 shown and described with respect to FIG. 1.

In an example, the method 600 begins when the power management system determines (605) an operating mode of the data storage device. In an example, the operating mode of the data storage device includes, but is not limited to, a sequential sustained read mode, a sequential sustained write mode, a burst sequential write mode, a sustain random read mode and a burst random read mode.

In response to determining the operating mode of the data storage device, the power management system determines (610) whether the data storage device is in the sustained write mode. If the power management system determines (610) the data storage device is not in the sustained write mode, the power management system maintains (615) the current power state of the data storage device.

However, if the power management system determines (610) that the data storage device is in the sustained write mode, the power management system analyzes (620) one or more commands in a command queue. In an example, the analysis is used to determine one or more properties associated with each command in the command queue. For example, the power management system analyses the command queue to determine (625) whether a number of write commands in the command queue exceeds a write command threshold.

If the power management system determines (625) the number of write commands in the command queue does not exceed the write command threshold, the power management system maintains (615) the current power state of the data storage device. However, if the power management system determines (625) the number of write commands in the command queue exceeds the write command threshold, the power management system also determines (630) the run length of each of the write commands in the command queue.

In an example, if the power management system determines (630) the run length of write commands in the command queue does not exceed a run length threshold, the power management system maintains (615) the current power state of the data storage device. However, in an example, if the power management system determines (630) the run length of write commands in the command queue exceeds the run length threshold, the power management system determines (635) whether a relocation operation is needed on an inactive meta-die.

For example, the relocation system and/or the power management system will determine a number of free SLC memory blocks in one or more of the inactive meta-dies and determine, based at least in part, on the number of free SLC memory blocks, whether to initiate a relocation operation on that particular inactive meta-die. In an example, the relocation operation is an OCC relocation operation.

Based, at least in part, on determining a relocation operation should be performed on one or more of the inactive meta-dies, the power management system changes (640) a power state of the data storage device. For example, the power management system changes the power state of the data storage device from a first state (e.g., an active state) to a second state (e.g., a sustained state). As part of this process, the power management system changes (e.g., reduces) (645) a clock frequency of the processor of the data storage device.

In response to the clock frequency of the controller being lowered, the relocation system performs (650) one or more relocation operations on one or more of the inactive meta-dies. In an example, relocation operations may be performed on a single meta-die or on multiple meta-dies so long as the data storage device is in the sustained state and/or the sustained sequential write mode. For example a first relocation operation can be performed on a first inactive meta-die and, upon completion of the first relocation operation, a second relocation operation is performed on a second inactive meta-die.

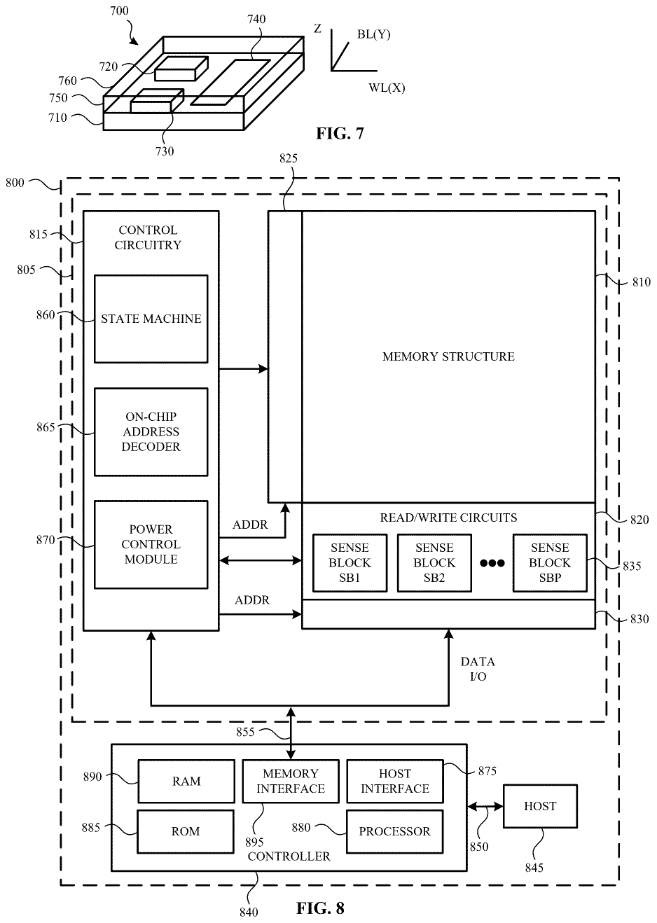

FIG. 7-FIG. 8 describe example storage devices that may be used with or otherwise implement the various features described herein. For example, the storage devices shown and described with respect to FIG. 7-F IG. 8 may include various systems and components that are similar to the systems and components shown and described with respect to FIG. 1. For example, the controller 840 shown and described with respect to FIG. 8 may be similar to the controller 150 of FIG. 1. Likewise, the memory dies 805 may be similar to the first memory die 165 and/or the second memory die 170 of FIG. 1.

FIG. 7 is a perspective view of a storage device 700 that includes three-dimensional (3D) stacked non-volatile memory according to an example. In this example, the storage device 700 includes a substrate 710. Blocks of memory cells are included on or above the substrate 710. The blocks may include a first block (BLK0 720) and a second block (BLK1 730). Each block may be formed of memory cells (e.g., non-volatile memory elements). The substrate 710 may also include a peripheral area 740 having support circuits that are used by the first block and the second block.

The substrate 710 may also carry circuits under the blocks, along with one or more lower metal layers which are patterned in conductive paths to carry signals from the circuits. The blocks may be formed in an intermediate region 750 of the storage device 700. The storage device may also include an upper region 760. The upper region 760 may include one or more upper metal layers that are patterned in conductive paths to carry signals from the circuits. Each block of memory cells may include a stacked area of memory cells. In an example, alternating levels of the stack represent word lines. While two blocks are depicted, additional blocks may be used and extend in the x-direction and/or the y-direction.

In an example, a length of a plane of the substrate 710 in the x-direction represents a direction in which signal paths for word lines or control gate lines extend (e.g., a word line or drain-end select gate (SGD) line direction) and the width of the plane of the substrate 710 in the y-direction represents a direction in which signal paths for bit lines extend (e.g., a bit line direction). The z-direction represents a height of the storage device 700.

FIG. 8 is a functional block diagram of a storage device 800 according to an example. In an example, the storage device 800 may be the 3D stacked non-volatile storage device 400 shown and described with respect to FIG. 4. The components depicted in FIG. 8 may be electrical circuits. In an example, the storage device 800 includes one or more memory dies 805. Each memory die 805 includes a three-dimensional memory structure 810 of memory cells (e.g., a 3D array of memory cells), control circuitry 815, and read/write circuits 820. In another example, a two-dimensional array of memory cells may be used. The memory structure 810 is addressable by word lines using a first decoder 825 (e.g., a row decoder) and by bit lines using a second decoder 830 (e.g., a column decoder). The read/write circuits 820 may also include multiple sense blocks 835 including SB1, SB2, . . . SBp (e.g., sensing circuitry) which allow pages of the memory cells to be read or programmed in parallel. The sense blocks 835 may include bit line drivers.

In an example, a controller 840 is included in the same storage device 800 as the one or more memory dies 805. In another example, the controller 840 is formed on a die that is bonded to a memory die 805, in which case each memory die 805 may have its own controller 840. In yet another example, a controller die controls all of the memory dies 805.

Commands and data may be transferred between a host 845 and the controller 840 using a data bus 850. Commands and data may also be transferred between the controller 840 and one or more of the memory dies 805 by way of lines 855. In one example, the memory die 805 includes a set of input and/or output (I/O) pins that connect to lines 855.

The memory structure 810 may also include one or more arrays of memory cells. The memory cells may be arranged in a three-dimensional array or a two-dimensional array. The memory structure 810 may include any type of non-volatile memory that is formed on one or more physical levels of arrays of memory cells having an active area disposed above a silicon substrate. The memory structure 810 may be in a non-volatile memory device having circuitry associated with the operation of the memory cells, whether the associated circuitry is above or within the substrate.

The control circuitry 815 works in conjunction with the read/write circuits 820 to perform memory operations (e.g., erase, program, read, and others) on the memory structure 810. The control circuitry 815 may include registers, ROM fuses, and other devices for storing default values such as base voltages and other parameters.

The control circuitry 815 may also include a state machine 860, an on-chip address decoder 865 and a power control module 870. The state machine 860 may provide chip-level control of various memory operations. The state machine 860 may be programmable by software. In another example, the state machine 860 does not use software and is completely implemented in hardware (e.g., electrical circuits).

The on-chip address decoder 865 may provide an address interface between addresses used by host 845 and/or the controller 840 to a hardware address used by the first decoder 825 and the second decoder 830.

The power control module 870 may control power and voltages that are supplied to the word lines and bit lines during memory operations. The power control module 870 may include drivers for word line layers in a 3D configuration, select transistors (e.g., SGS and SGD transistors) and source lines. The power control module 870 may include one or more charge pumps for creating voltages.

The control circuitry 815, the state machine 860, the on-chip address decoder 865, the first decoder 825, the second decoder 830, the power control module 870, the sense blocks 835, the read/write circuits 820, and/or the controller 840 may be considered one or more control circuits and/or a managing circuit that perform some or all of the operations described herein.

In an example, the controller 840, is an electrical circuit that may be on-chip or off-chip. Additionally, the controller 840 may include one or more processors 880, ROM 885, RAM 890, memory interface 895, and host interface 875, all of which may be interconnected. In an example, the one or more processors 880 is one example of a control circuit. Other examples can use state machines or other custom circuits designed to perform one or more functions. Devices such as ROM 885 and RAM 890 may include code such as a set of instructions. One or more of the processors 880 may be operable to execute the set of instructions to provide some or all of the functionality described herein.

Alternatively or additionally, one or more of the processors 880 may access code from a memory device in the memory structure 810, such as a reserved area of memory cells connected to one or more word lines. The memory interface 895, in communication with ROM 885, RAM 890, and one or more of the processors 880, may be an electrical circuit that provides an electrical interface between the controller 840 and the memory die 805. For example, the memory interface 895 may change the format or timing of signals, provide a buffer, isolate from surges, latch I/O, and so forth.

The one or more processors 880 may issue commands to control circuitry 815, or any other component of memory die 805, using the memory interface 895. The host interface 875, in communication with the ROM 885, the RAM 895, and the one or more processors 880, may be an electrical circuit that provides an electrical interface between the controller 840 and the host 845. For example, the host interface 875 may change the format or timing of signals, provide a buffer, isolate from surges, latch I/O, and so on. Commands and data from the host 845 are received by the controller 840 by way of the host interface 875. Data sent to the host 845 may be transmitted using the data bus 850.

Multiple memory elements in the memory structure 810 may be configured so that they are connected in series or so that each element is individually accessible. By way of a non-limiting example, flash memory devices in a NAND configuration (e.g., NAND flash memory) typically contain memory elements connected in series. A NAND string is an example of a set of series-connected memory cells and select gate transistors.

A NAND flash memory array may also be configured so that the array includes multiple NAND strings. In an example, a NAND string includes multiple memory cells sharing a single bit line and are accessed as a group. Alternatively, memory elements may be configured so that each memory element is individually accessible (e.g., a NOR memory array). The NAND and NOR memory configurations are examples and memory cells may have other configurations.

The memory cells may be arranged in the single memory device level in an ordered array, such as in a plurality of rows and/or columns. However, the memory elements may be arrayed in non-regular or non-orthogonal configurations, or in structures not considered arrays.

In an example, a 3D memory structure may be vertically arranged as a stack of multiple 2D memory device levels. As another non-limiting example, a 3D memory array may be arranged as multiple vertical columns (e.g., columns extending substantially perpendicular to the major surface of the substrate, such as in the y direction) with each column having multiple memory cells. The vertical columns may be arranged in a two-dimensional arrangement of memory cells, with memory cells on multiple vertically stacked memory planes. Other configurations of memory elements in three dimensions can also constitute a 3D memory array.

In another example, in a 3D NAND memory array, the memory elements may be coupled together to form vertical NAND strings that traverse across multiple horizontal memory device levels. Other 3D configurations can be envisioned wherein some NAND strings contain memory elements in a single memory level while other strings contain memory elements which span through multiple memory levels. 3D memory arrays may also be designed in a NOR configuration and in a ReRAM configuration.

One of ordinary skill in the art will recognize that the technology described herein is not limited to a single specific memory structure, but covers many relevant memory structures within the spirit and scope of the technology as described herein and as understood by one of ordinary skill in the art. One of skill in the art also will note that while the invention is described in terms of SLC and QLC memory blocks, in some embodiments, triple-level cell (TLC) memory blocks and multi-level cell (MLC) blocks may be substituted for QLC memory blocks.

Accordingly, examples of the present disclosure describe a method, comprising: determining an operating mode of a data storage device; based, at least in part, on determining the data storage device is operating in a particular operating mode: analyzing one or more commands in a command queue; determining one or more properties associated with each command in the command queue; based, at least in part, on the one or more properties associated with each command, determining a storage state of an inactive meta-die of the data storage device; changing a power state of the data storage device from a first state to a second state in which a clock frequency of at least one processor of the data storage device is reduced when compared to the clock frequency of the at least one processor in the first state; and diverting power saved by reducing the clock frequency of the at least one processor to the inactive meta-die thereby causing the inactive meta-die to be an active meta-die. In an example, the method also includes performing a relocation operation on one or more memory blocks of one or more memory dies of the active meta-die. In an example, the relocation operation is an on-chip copy operation. In an example, the operating mode of the data storage device is a sustained write mode. In an example, analyzing one or more commands in the command queue comprises determining a type of each command in the command queue. In an example, the method also includes determining a number of write commands in the command queue; and determining whether the number of write commands in the command queue exceeds a write command threshold. In an example, the method also includes determining a run length of each write command in the command queue; and determining whether a combined run length of each write command in the command queue exceeds a run length threshold. In an example, changing the power state of the data storage device from the first state to the second state is based, at least in part, on determining an amount of available storage on the inactive meta-die is less than a storage threshold.

Additional examples describe a data storage device, comprising: at least one controller; and a power management system associated with the controller and operable to: determine whether the data storage device is operating in a sustained write mode; based, at least in part, on determining the data storage device is operating in the sustained write mode: analyze one or more commands in a command queue; determine one or more properties associated with each command in the command queue; determine whether a value associated with the one or more properties exceeds a properties threshold; based, at least in part, on determining the value associated with the one or more properties exceeds the properties threshold: determine a storage state of an inactive meta-die of the data storage device; based, at least in part, on the storage state of the inactive meta-die, change a clock frequency of at least one processor of the data storage device from a first clock frequency to a second clock frequency, the second clock frequency being lower than the first clock frequency; and provide power saved by changing the clock frequency of the at least one processor from the first clock frequency to the second clock frequency to the inactive meta-die, thereby causing the inactive meta-die to be an active meta-die. In an example, the power management system is further operable to perform a relocation operation on one or more memory blocks of one or more memory dies of the active meta-die. In an example, the relocation operation is an on-chip copy operation. In an example, analyzing one or more commands in the command queue comprises determining a type of each command in the command queue. In an example, the power management system is further operable to: determine a number of write commands in the command queue; and determine whether the number of write commands in the command queue exceeds a write command threshold. In an example, the power management system is further operable to: determine a run length of each write command in the command queue; and determine whether a combined run length of each write command in the command queue exceeds a run length threshold. In an example, changing the clock frequency of the at least one processor of the data storage device from the first clock frequency to the second clock frequency is based, at least in part, on a determination than an amount of available storage in the inactive meta-die is less than a storage threshold.

Still other examples describe a data storage device, comprising: means for determining whether the data storage device is operating in a sustained write mode; means for analyzing one or more commands in a command queue; means for determining one or more properties associated with each command in the command queue; means for determining whether a value associated with the one or more properties exceeds a properties threshold; means for determining a storage state of an inactive meta-die of the data storage device; means for changing a clock frequency of at least one processor of the data storage device from a first clock frequency to a second clock frequency, the second clock frequency being lower than the first clock frequency; and means for providing power saved by changing the clock frequency of the at least one processor from the first clock frequency to the second clock frequency to the inactive meta-die, thereby causing the inactive meta-die to be an active meta-die. In an example, the data storage device also includes means for performing a relocation operation on one or more memory blocks of one or more memory dies of the active meta-die. In an example, the relocation operation is an on-chip copy operation. In an example, the means for analyzing the one or more commands in the command queue determines a type of each command in the command queue. In an example, the power management system further comprises: means for determining a number of write commands in the command queue; and means for determining whether the number of write commands in the command queue exceeds a write command threshold.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks. Additionally, it is contemplated that the flowcharts and/or aspects of the flowcharts may be combined and/or performed in any order.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

1. A method, comprising:
determining an operating mode of a data storage device;
based, at least in part, on determining the data storage device is operating in a particular operating mode:
analyzing one or more commands in a command queue;
determining one or more properties associated with each command in the command queue;
based, at least in part, on the one or more properties associated with each command, determining a storage state of an inactive meta-die of the data storage device, the storage state indicating whether a relocation operation should be performed on the inactive meta-die;
based, at least in part, on determining the storage state indicates the relocation operation should be performed on the inactive meta-die, changing a power state of the data storage device from a first state to a second state in which a clock frequency of at least one processor of the data storage device is reduced when compared to the clock frequency of the at least one processor in the first state; and
diverting power saved by reducing the clock frequency of the at least one processor to the inactive meta-die thereby causing the inactive meta-die to be an active meta-die such that the relocation operation is performed on the active meta-die.

2. The method of claim 1, further comprising performing a relocation operation on one or more memory blocks of one or more memory dies of the active meta-die.

3. The method of claim 2, wherein the relocation operation is an on-chip copy operation.

4. (canceled)

5. The method of claim 1, wherein analyzing one or more commands in the command queue comprises determining a type of each command in the command queue.

6. The method of claim 5, further comprising:
determining a number of write commands in the command queue; and
determining whether the number of write commands in the command queue exceeds a write command threshold.

7. The method of claim 6, further comprising:
determining a run length of each write command in the command queue; and
determining whether a combined run length of each write command in the command queue exceeds a run length threshold.

8. The method of claim 1, wherein changing the power state of the data storage device from the first state to the second state is based, at least in part, on determining an amount of available storage on the inactive meta-die is less than a storage threshold.

9. A data storage device, comprising:
at least one controller; and
a power management system associated with the controller and operable to:
determine whether the data storage device is operating in a sustained write mode;
based, at least in part, on determining the data storage device is operating in the sustained write mode:
analyze one or more commands in a command queue;
determine one or more properties associated with each command in the command queue;
determine whether a value associated with the one or more properties exceeds a properties threshold;
based, at least in part, on determining the value associated with the one or more properties exceeds the properties threshold:
determine a storage state of an inactive meta-die of the data storage device, the storage state indicating whether a relocation operation should be performed on the inactive meta-die;
based, at least in part, on determining the storage state indicates the relocation operation should be performed on the inactive meta-die, change a clock frequency of at least one processor of the data storage device from a first clock frequency to a second clock frequency, the second clock frequency being lower than the first clock frequency; and
provide power saved by changing the clock frequency of the at least one processor from the first clock frequency to the second clock frequency to the inactive meta-die, thereby causing the inactive meta-die to be an active meta-die such that the relocation operation is performed on the active meta-die.

10. The data storage device of claim 9, wherein the power management system is further operable to perform a relocation operation on one or more memory blocks of one or more memory dies of the active meta-die.

11. The data storage device of claim 10, wherein the relocation operation is an on-chip copy operation.

12. The data storage device of claim 9, wherein analyzing one or more commands in the command queue comprises determining a type of each command in the command queue.

13. The data storage device of claim 12, wherein the power management system is further operable to:
determine a number of write commands in the command queue; and
determine whether the number of write commands in the command queue exceeds a write command threshold.

14. The data storage device of claim 13, wherein the power management system is further operable to:
determine a run length of each write command in the command queue; and
determine whether a combined run length of each write command in the command queue exceeds a run length threshold.

15. The data storage device of claim 9, wherein changing the clock frequency of the at least one processor of the data storage device from the first clock frequency to the second clock frequency is based, at least in part, on determining than an amount of available storage in the inactive meta-die is less than a storage threshold.

16. A data storage device, comprising:
means for determining whether the data storage device is operating in a sustained write mode;
means for analyzing one or more commands in a command queue;
means for determining one or more properties associated with each command in the command queue;
means for determining whether a value associated with the one or more properties exceeds a properties threshold;
means for determining a storage state of an inactive meta-die of the data storage device, the storage state indicating whether a relocation operation should be performed on the inactive meta-die;
based, at least in part, on determining the storage state indicates the relocation operation should be performed on the inactive meta-die, means for changing a clock frequency of at least one processor of the data storage device from a first clock frequency to a second clock frequency, the second clock frequency being lower than the first clock frequency; and
means for providing power saved by changing the clock frequency of the at least one processor from the first clock frequency to the second clock frequency to the inactive meta-die, thereby causing the inactive meta-die to be an active meta-die such that the relocation operation is performed on the active meta-die.

17. The data storage device of claim 16, further comprising means for performing a relocation operation on one or more memory blocks of one or more memory dies of the active meta-die.

18. The data storage device of claim 17, wherein the relocation operation is an on-chip copy operation.

19. The data storage device of claim 16, wherein the means for analyzing the one or more commands in the command queue determines a type of each command in the command queue.

20. The data storage device of claim 19, wherein the power management system further comprises:
means for determining a number of write commands in the command queue; and
means for determining whether the number of write commands in the command queue exceeds a write command threshold.

21. The method of claim 1, wherein diverting power saved by reducing the clock frequency of the at least one processor to the inactive meta-die causes the relocation operation to be performed on the active meta-die while conforming to a power constraint of a communication protocol of the data storage device.
